(19) United States
(12) Patent Application Publication
(10) Pub. No.: US 2015/0015102 A1
(43) Pub. Date: Jan. 15, 2015

(54) MOTOR AND A METHOD OF ASSEMBLING THE SAME

(71) Applicant: AGENCY FOR SCIENCE TECHNOLOGY AND RESEARCH, Singapore (SG)

(72) Inventors: Chiew Leong Wong, Singapore (SG); Ralph Stephen Viskochil, Singapore (SG); Chao Bi, Singapore (SG)

(73) Assignee: AGENCY FOR SCIENCE, TECHNOLOGY AND RESEARCH, Singapore (SG)

(21) Appl. No.: 14/378,642

(22) PCT Filed: Feb. 13, 2013
(86) PCT No.: PCT/SG2013/000055

§ 371 Date: Aug. 13, 2014

Related U.S. Application Data
(60) Provisional application No. 61/597,870, filed on Feb. 13, 2012.

(51) Int. Cl. H02K 3/26; H02K 16/02; H02K 3/28; H02K 15/02

(52) U.S. Cl. CPC H02K 3/26; H02K 15/02; H02K 16/02; H02K 3/28
USPC 310/71; 29/598; 310/156.37

(57) ABSTRACT

In various embodiments, a motor may be provided. The motor may include a base, a first rotor, a second rotor and a stator arranged between the first rotor and the second rotor, the stator including an alignment member for aligning the stator to the base.

### CROSS-REFERENCE TO RELATED APPLICATION

This application claims the benefit of priority of U.S. provisional application No. 61/597,870, filed 13 Feb. 2012, the content of it being hereby incorporated by reference in its entirety for all purposes.

### TECHNICAL FIELD

The present invention generally relates to a motor and a method of assembling the same.

### BACKGROUND

Mobile computing and/or communication devices are becoming smaller thereby driving the weight and size of data storage devices down, while requiring large storage capacity in the terabyte range and low power consumption. For example, many mobile computing devices are assuming a thin profile and small form factor for ease of transport and universal operationability. Traditional data storage devices for storing large amounts of data, such as disk drives, have a thickness which is incompatible for such applications.

Thus, what is needed is a light-weight, ultra thin data storage device with a small form factor and yet be capable of large storage capacities at low power consumption levels. At the same time, the data storage device needs to be easily assembled. Furthermore, other desirable features and characteristics will become apparent from the subsequent detailed description, taken in conjunction with the accompanying drawings and this background of the disclosure.

### SUMMARY

In various embodiments, a motor may be provided. The motor may include a base, a first rotor, a second rotor and a stator arranged between the first rotor and the second rotor, the stator including an alignment member for aligning the stator to the base.

In various embodiments, a method for assembling a motor is provided. The method may include providing a base, a first rotor, a second rotor and a stator. The method may further provide assembling the base, the first rotor, the second rotor and the stator such that the stator is arranged between the first rotor and the second rotor and the stator is aligned to the base by an alignment member of the stator.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a schematic having a cross sectional side view of an axial field motor according to various embodiments.

FIG. 2A shows a schematic having a cross-sectional side view of a portion of an assembled motor according to various embodiments; FIG. 2B shows a schematic having a cross-sectional side view of an assembled motor according to various embodiments; and FIG. 2C shows a schematic having a perspective view of a housing including the base according to various embodiments.

FIG. 3 is a schematic showing a planar cross sectional view of a stator according to various embodiments.

FIG. 4A shows a schematic having a cross-sectional side view of an assembled motor according to various embodiments; FIG. 4B shows a schematic having a cross-sectional side view of an motor before being assembled; FIG. 4C shows a schematic having a cross-sectional side view an assembled motor according to various embodiments; and FIG. 4D shows a schematic having a perspective view of a housing including the base according to various embodiments.

FIG. 5A shows a schematic having a perspective view of a stator according to various embodiments; and FIG. 5B shows a schematic having a cross sectional top view of the stator shown in FIG. 5A according to various embodiments.

FIG. 6A shows a schematic having a perspective view of a stator according to various embodiments; and FIG. 6B shows a schematic having a cross sectional top view of the stator shown in FIG. 6A according to various embodiments.

FIG. 7 shows a schematic having a top view of a stator according to various embodiments.

FIG. 8 shows a schematic illustrating a method for assembling a motor according to various embodiments.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

It is proposed to provide a motor, in particular but not limited to a motor for a product such as a data storage device. The product can be a mobile consumer electronic device which can be operable in various orientations, and thus it should be understood that the terms “top”, “bottom”, “base”, “down”, “sideways”, “downwards” etc., when used in the following description are used for convenience and to aid understanding of relative positions or directions, and not intended to limit the orientation of the motor or the product incorporating the motor.

Various aspects of this disclosure provide a motor that is able to address at least partially some of the abovementioned challenges.

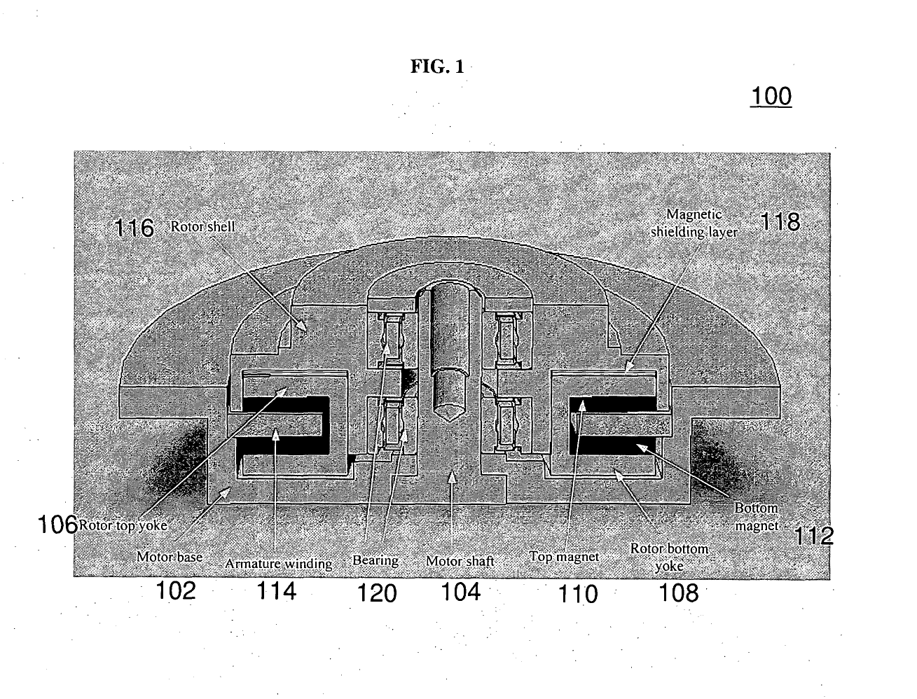

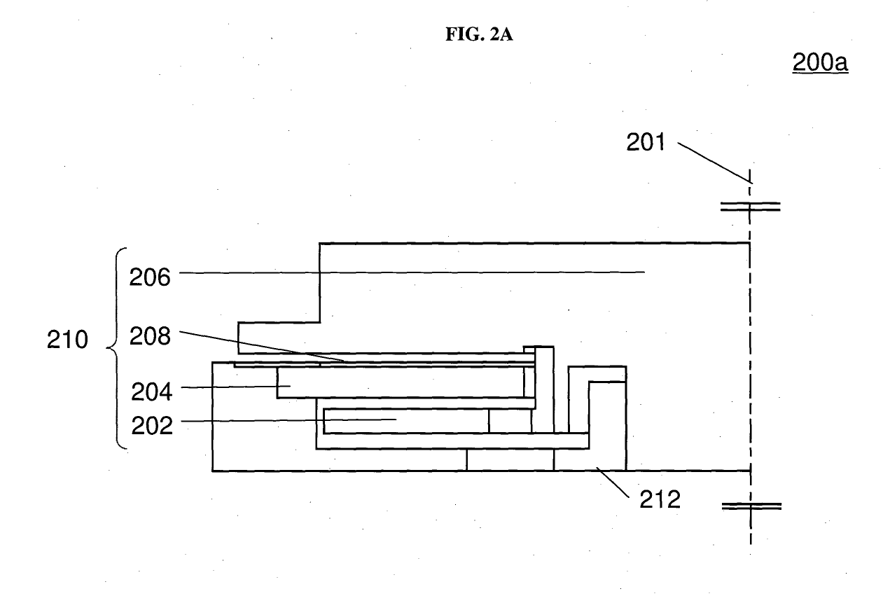

FIG. 1 shows a schematic 100 having a cross sectional side view of an axial field motor according to various embodiments. The motor may include a motor base 102. The motor may further include a motor shaft 104 extending from the motor base 102. The motor further includes a rotor yoke including a rotor top yoke 106 and a rotor bottom yoke 108. The rotor yoke may be pivotally mounted about a geometric axis of rotation Xr, in relation to the motor base 102. The motor may also include a magnet disk including a top magnet 110 and a bottom magnet 112. The top magnet 110 may be positioned in contact with the rotor top yoke 106. The bottom magnet 112 may be positioned in contact with the rotor bottom yoke 108. The motor may further include a stator having an armature winding 114 positioned between the top magnet 110 and the bottom magnet 112. The motor may also include a rotor shell 116 disposed over the magnet disc so as to enclose all the components therewithin. Further, the motor may include a magnetic shielding layer 118 positioned between the rotor top yoke 106 and the rotor shell 116 so as to shield the magnetic field generated by the magnetic disc. The motor may be configured to rotate about the first axis or geometric axis Xr either on hydrodynamic bearings or ball bearings 120. While FIG. 1 shows that the stator (having armature winding 114) is sandwiched by magnets 110 and 112, it may be envisioned that magnets are provided only on one side of the stator or armature winding 114.

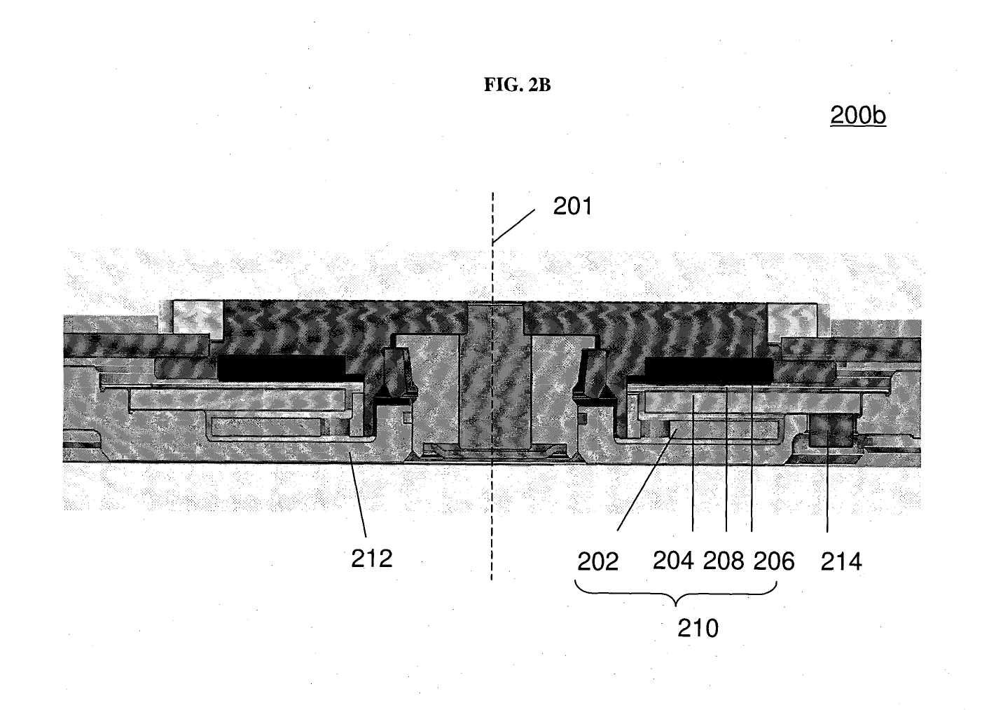

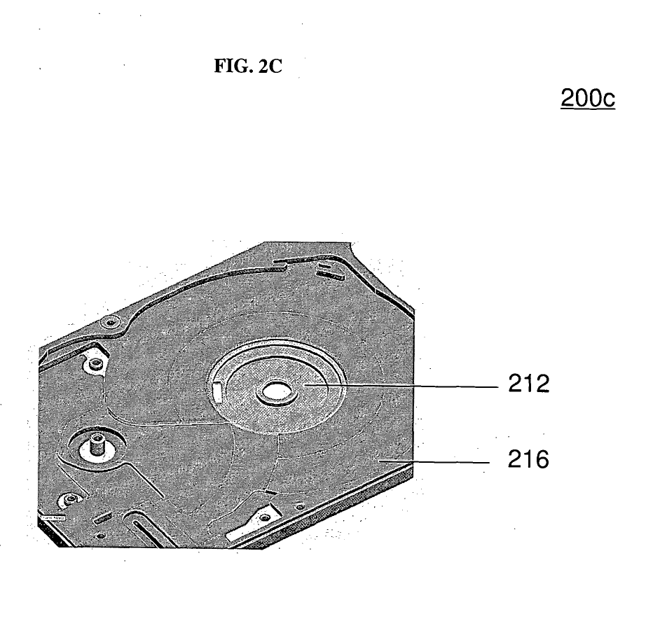

FIG. 2A shows a schematic 200a having a cross-sectional side view of a portion of an assembled motor according to various embodiments. For simplicity, only half of the motor from an axis or center line 201 is shown in FIG. 2A, wherein the center line 201 defines an axis of rotation of the motor, i.e. an axis around which the motor is rotated. FIG. 2B shows a schematic 200b having a cross-sectional side view of an assembled motor according to various embodiments.

The motor may include a first rotor 202, a stator 204, and a second rotor 206. The stator 204 may be arranged between the first rotor 202 and the second rotor 206. In various embodiments, the stator 204 arranged between the first rotor 202 and the second rotor 206 may include that the projection of the stator 204 onto the axis 201 is between the projection of the first rotor 202 onto the axis 201 and the projection of the second rotor 206 onto the axis 201. The projections of the first rotor 202, the stator 204 and the second rotor 206 may lie sequentially along the axis 201, wherein parts of the projections may or may not coincide with each other. In various embodiments, the stator 204 arranged between the first rotor 202 and the second rotor 206 may include that the stator 204 is surrounded by the first rotor 202 and the second rotor 206. In various embodiments, the stator 204 arranged between the first rotor 202 and the second rotor 206 may include that at least a portion of the stator 204 may be arranged over at least a portion of the first rotor 202 and at least a portion of the second rotor 206 may be arranged over at least a portion of the stator 204.

The first rotor 202, the stator 204 and the second rotor 206 in such an arrangement may be referred to as a motor sub-assembly 210. In other words, the stator 204, the first rotor 202 and the second rotor 206 may form a motor sub-assembly 210. The motor sub-assembly 210 may also further include a bias ring 208.

The motor may further include a base 212. The motor sub-assembly 210 may be on the base 212. The motor sub-assembly 210 may be mounted on the base 212. The stator 204 may be attached to the base 212. In various embodiments, the stator 204 may be attached to the base 212 by a fastener or fasteners. In various embodiments, the stator 204 may be attached to the base 212 by an adhesive such as epoxy.

The motor may further include an adaptor 214. The adapter 214 may be configured to supply current to the stator 204. The adapter 214 may be configured for operable coupling with a contact of the stator 204.

In various embodiments, the base 212 may form at least a portion of a housing. FIG. 2C shows a schematic 200c having a perspective view of a housing 216 including the base 212 according to various embodiments. The housing 216 may contain the device (e.g. a data storage device such as a hard disk) in which the motor is a part.

In various embodiments, the various components such as the first rotor 202, the stator 204 and the second rotor 206 may be fully assembled and mounted on a part of the device such as the housing 216 of the device. In various embodiments, the stator 204 may be fixedly coupled or secured to the part of the device, e.g. to the housing of the device.

According various embodiments, the motor may further include a bias ring 208 coupled to the stator 204. In various embodiments, the bias ring 208 may be arranged on the stator 204. In various embodiments, the bias ring 208 may be embedded in the stator 204, or may be formed as an integral part of the stator 204.

In an embodiment, the second rotor 206 may include a hub coupled with at least one fluid dynamic bearing. The bias ring 208 may be attached to the base 212 such that interaction with magnets provided in the motor (e.g. provided in the second rotor 206) creates a desired magnetic bias force such as between the second rotor 206 (e.g. the hub of the second rotor 206) and the base 212.

It is understood that the bias ring 208 may be optionally included in the motor when necessary, e.g. when fluid dynamic bearings are used in the motor 200.

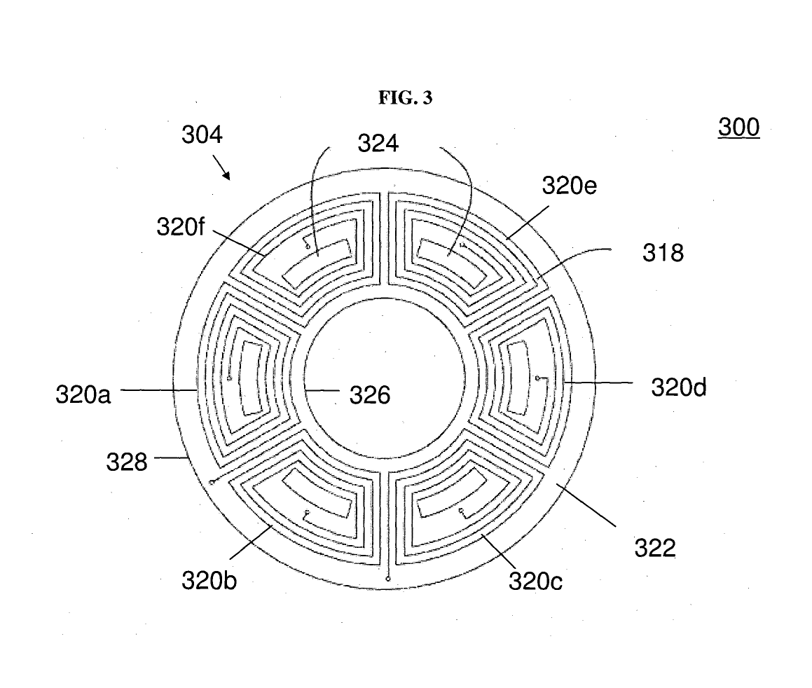

FIG. 3 is a schematic 300 showing a planar cross sectional view of a stator 304 according to various embodiments. The stator 304 may include an armature winding 318. The armature winding 318 may be formed from a plurality of coils 320a, 320b, 320c, 320d, 320e and 320f. In other words, the stator 304 may include a plurality of coils 320a, 320b, 320c, 320d, 320e and 320f. For avoidance of doubt, although FIG. 3 shows six coils 320a, 320b, 320c, 320d, 320e and 320f, other numbers of coils may be possible. The plurality of coils 320a, 320b, 320c, 320d, 320e and 320f may be provided on a substrate 322, such as a printed circuit board (PCB). The substrate 322 may be a substantially planar substrate. The armature winding 318 may be formed by printed circuit board traces, bonded wires, fine pattern coils or other wire and circuit technologies.

For example, the armature winding 318 may be formed by six coils 320a, 320b, 320c, 320d, 320e and 320f. The six coils may be divided into three pairs. Coils 320a and 320b may form a first pair. Coils 320b and 320e may form a second pair. Coils 320c and 320f may form a third pair. The coils in each pair may be of the same electrical degree (or phase) at any point in time. One pair may differ from another pair by 120 electrical degrees. The armature winding 318 may be described as a “120 electrical degrees” concentrated winding. In various embodiments where the armature winding 318 may be described as “120 electrical degrees” concentrated winding, the winding 318 utilises fundamental or the second order electromagnetic field harmonics in spindle motor operations.

In various embodiments, the stator 304 may including a plurality of openings 324. The plurality of openings 324 may also be used for alignment of the stator to the base. Each coil of the plurality of coils 320a, 320b, 320c, 320d, 320e and 320f may form a spiral pattern. Each coil may surround one of the plurality of openings 324. Each coil of the plurality of coils 320a, 320b, 320c, 320d, 320e and 320f may be arranged in a spiral manner around each opening of the plurality of openings 324.

In various embodiments, the plurality of coils 320a, 320b, 320c, 320d, 320e and 320f may be distributed between an inner edge 326 of the substrate 322 and an outer edge 328 of the substrate 324. The plurality of coils 320a, 320b, 320c, 320d, 320e and 320f may be in a plane defined by the substrate 322.

The substrate may include a plurality of layers. The plurality of coils 320a, 320b, 320c, 320d, 320e and 320f may be on different layers of the plurality of layers. For instance, the substrate 322 may include a first layer and a second layer. Coils 320a, 320d may be on a first surface of the first layer. Coils 320b, 320e may be between a second surface of the first layer (opposite the first surface of the first layer) and a first surface of a second layer. The second surface of the first layer may be in contact with the first surface of the second layer. Coils 320c, 320f may be on a second surface of the second layer (opposite the first surface of the second layer). The plurality of coils 320a, 320b, 320c, 320d, 320e and 320f may form a two dimensional multi phase winding. In other words, the armature winding 318 may be a two dimensional winding. The winding 318 (or plurality of coils 320a, 320b, 320c, 320d, 320e and 320f) in different surfaces or layers may be electrically connected by conductive vias.

The effective length of the winding 322 lies in a radial directions that extends from the inner edge 326 of the substrate 322 to the outer edge 328 of the substrate 322. The winding may be arranged such that the effective length of the winding is increased without increasing the length of the winding oriented circumferentially (“end windings”). Only the effective length may contribute to the power generated by the motor.

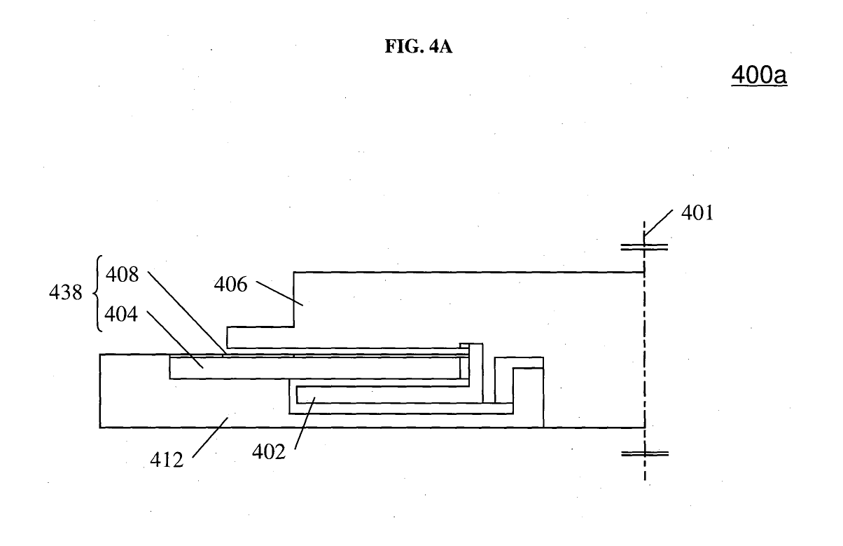

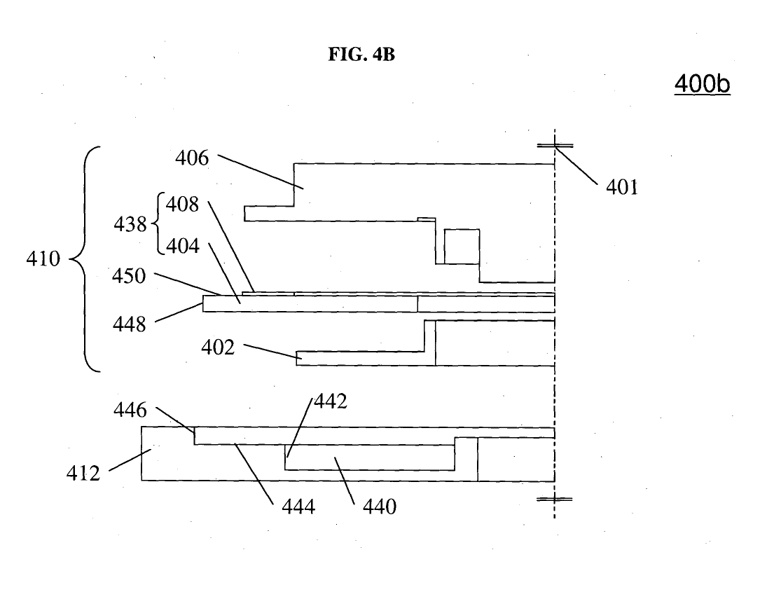

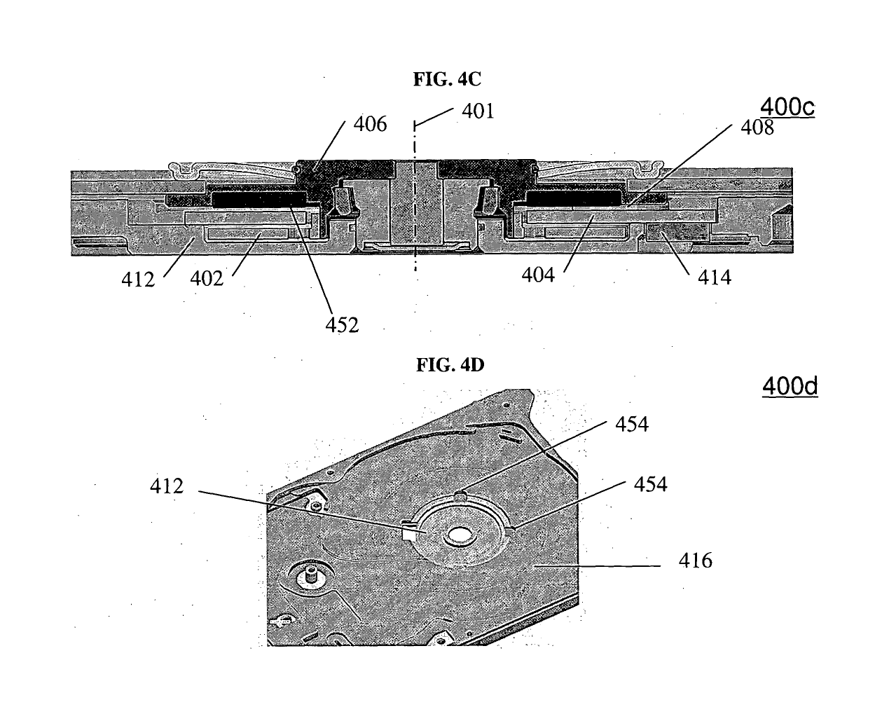

FIG. 4A shows a schematic 400a having a cross-sectional side view of an assembled motor according to various embodiments. FIG. 4B shows a schematic 400b having a cross-sectional side view of a motor before being assembled. The stator assembly 438 may include a stator 404. The stator assembly 438 may further a bias ring 408. The first rotor 402 and the second rotor 406 may be coupled together along center line 401 with the stator assembly 438 disposed therebetween. As can be appreciated, this may be performed in a top-down manner. The stator assembly 438 may be disposed in a gap defined by the operable parts of the first rotor 402 and the second rotor 406 (ie. the stator assembly 438 is between the first rotor 402 and the second rotor 406). The stator 404, the first rotor 402 and the second rotor 406 may form the motor sub-assembly 410. In other words, the motor sub-assembly 410 may include the stator 404, the first rotor 402 and the second rotor 406. The motor sub-assembly 410 may further include the bias ring 408. In addition, the motor sub-assembly 410 may also include bearings such as fluid dynamics bearings.

The motor sub-assembly 410 and a base 412 may be presented to each other in a top-down fashion for assembly. The base 412 may form at least a part or portion of a housing. The motor sub-assembly 410 and the base 412 may be arranged together such that the first rotor 402 is received in a motor cavity 440 in the base 412. In other words, the motor cavity 440 may be configured to receive the first rotor 402. The base may further include a step. The step may be formed adjacent to the motor cavity 440. The step may include a side wall 442 of the motor cavity 440 and a rest 444 substantially perpendicular to the side wall 442 of the motor cavity 440. The step may further include a side surface 446. The rest 444 may be configured to receive the stator 404. The stator 404 may be coupled to the base 412, preferably by adhering the outer edge or circumferential side 448 of the stator 404 to the complementary side surface 446. The stator 404 may be attached to the base 412. The stator 404 may be attached to the base 412 using an adhesive such as epoxy. Alternatively, the stator 404 may be attached to the base 412 by means or fasteners. The stator may be partially exposed. In various embodiments, forces may be applied in a top-down fashion to the exposed part 450 of the stator 404, to abut the stator 404 to the rest 444, thereby achieving a predetermined height of the stator 404 relative to the base and to facilitate coupling between the stator 404 to the base 412. Concurrently, a desired spacing between the stator 404 and the first rotor 402 and a desired spacing between the stator 404 and the second rotor 406 may be achieved.

FIG. 4C shows a schematic 400c having a cross-sectional side view an assembled motor according to various embodiments. The motor may include a first rotor 402, a stator 404, and a second rotor 406. The stator 404 may be arranged between the first rotor 402 and the second rotor 406. In various embodiments, the stator 404 arranged between the first rotor 402 and the second rotor 406 may include that the projection of the stator 404 onto the axis 401 is between the projection of the first rotor 402 onto the axis 401 and the projection of the second rotor 406 on to the axis 401. The projections of the first rotor 402, the stator 404 and the second rotor 406 may lie sequentially along the axis 401, wherein parts of the projections may or may not coincide with each other. In various embodiments, the stator 404 arranged between the first rotor 402 and the second rotor 406 may include that the stator 404 is surrounded by the first rotor 402 and the second rotor 406. In various embodiments, the stator 404 arranged between the first rotor 402 and the second rotor 406 may include that the stator 404 may be arranged over the first rotor 402 and the second rotor 406 may be arranged over the stator 404.

The motor may further include an adaptor 414. The adapter 414 may be configured to supply current to the stator 404. The adapter 414 may be configured for operable coupling with a contact of the stator 404.

The first rotor 402 or the second rotor 406 or both the first rotor 402 and the second rotor 406 may contain one or more permanent magnets 452. In other words, one or more permanent magnets 452 may be provided on one or both sides of the stator 404 having an armature winding.

FIG. 4D shows a schematic 400d having a perspective view of a housing 416 including the base 412 according to various embodiments. A motor sub-assembly including the first rotor 402, the second rotor 406 and the stator 404 may be mounted on the base 412. The base 412 may be or may form a portion of the housing 416. The housing 416 may contain the data storage device in which the motor is a part. In various embodiments, the housing 416 may contain at least the motor sub-assembly.

The base 412 may include a receiving member 454 (e.g. a complementary recess) for receiving an alignment member (e.g. a radial extension such as a tab) of the stator 404. The base 412 may include a plurality of receiving members 454 for receiving a plurality of alignment members of the stator 404. Each of the plurality of receiving members 454 may be configured to receive one of the plurality of alignment members. While FIG. 4D shows two receiving members 454 (e.g. a complementary recesses), any numbers of receiving members 454 may be also possible.

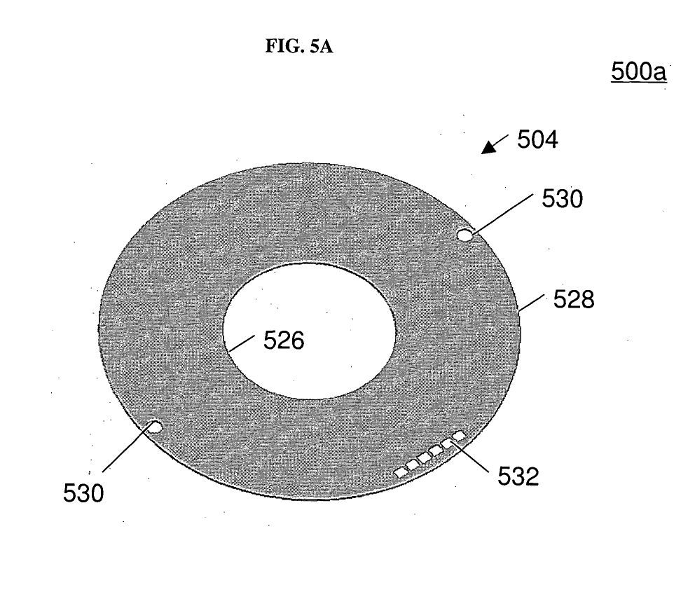

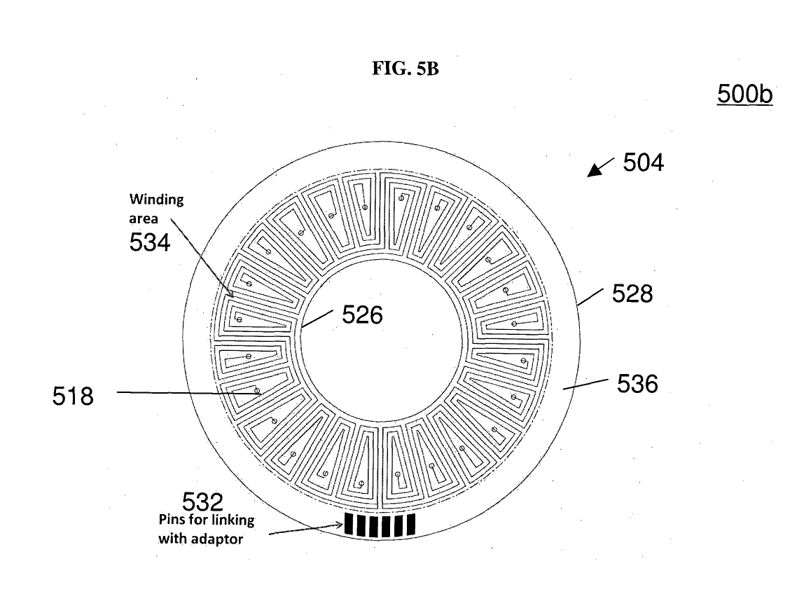

FIG. 5A shows a schematic 500a having a perspective view of a stator 504 according to various embodiments. The stator 504 may be configured for use with the motor (e.g. axial field motor) according to various embodiments. In particular, the stator 504 may be configured for use with a motor that is configured to facilitate top-down assembly. In various embodiments, the stator 504 may include an alignment member 530 for aligning the stator 504 to the base. The alignment member may be a protrusion. The base may include a receiving member for receiving the alignment member. The stator 504 may include more than one alignment members. In various embodiments, the stator 504 may include a contact 532. The contact 532 may be a pin. The contact 532 may be for operable coupling with a connector so as to establish operable electrical connection with circuitry for operating the motor.

FIG. 5B shows a schematic 500b having a cross sectional top view of the stator 504 shown in FIG. 5A according to various embodiments. The stator 504 may include a winding portion 534. The winding portion 534 may include an armature winding 518. The stator 504 may further include a non-winding portion 536. The non-winding portion 536 may be substantially free of the armature winding 518. In various embodiments, the non-winding portion 536 may include the contact 532. The contact 532 may be for operable coupling with an adaptor. The stator 504 may be the stator 204 shown in FIGS. 2A-B according to various embodiments and the adaptor may be the adaptor 214 shown in FIG. 2B according to various embodiments. The stator 504 may be the stator 404 shown in FIGS. 4A-C according to various embodiments and the adaptor may be the adaptor 414 shown in FIG. 4C according to various embodiments.

The contact 532 may be electrically coupled to the armature winding 518. In various embodiments, the winding portion 534 may be substantially annular. In various embodiments, the winding portion 534 may be adjacent to an inner edge 526. In various embodiments, the non-winding portion 536 may be substantially annular. In various embodiments, the non-winding portion 536 may be adjacent to an outer edge 528.

In various embodiments, at least a portion of the non-winding portion 536 may be the exposed part of the stator for the purpose of motor assembly.

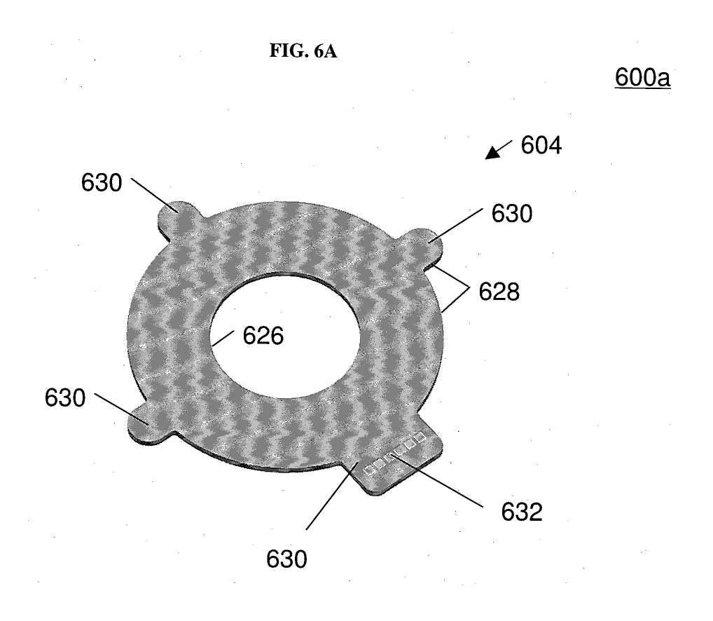

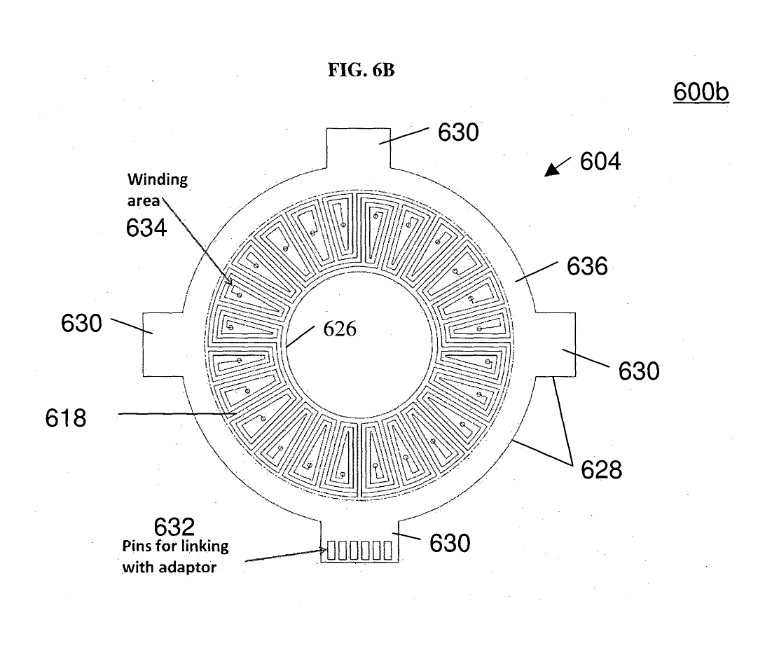

FIG. 6A shows a schematic 600a having a perspective view of a stator 604 according to various embodiments. The stator 604 may be configured for use with the motor (e.g. axial field motor) according to various embodiments. In various embodiments, the stator 604 may include an alignment member 630 for aligning the stator 604 to the base. In various embodiments, the alignment member 630 may include a radial extension of the stator 604. The radial extension may be a tab. The base may include a receiving member (e.g. a complementary recess) for receiving the alignment member (e.g. a radial extension such as a tab). In other words, the base may include a receiving member such as a recess configured to receive the radial extension. In various embodiments, the stator 604 may include more than one alignment members 630 (e.g. a plurality of radial extensions such as tabs). In various embodiments, the base may have a plurality of receiving members for receiving the plurality of alignment members (e.g. the plurality of radial extensions such as tabs). Each receiving member may receive one of the plurality of alignment members (e.g. the plurality of radial extensions such as tabs). In various embodiments, the stator 604 may include a contact 632. The contact 632 may be an electrical pad. The contact 632 may be for operable coupling with a connector so as to establish operable electrical connection with circuitry for operating the motor.

In various embodiments, the radial extension (such as a tab) may include the contact 632. In various alternate embodiments, the radial extension may be free of the contact 632. In various embodiments, one or more of the plurality of radial extensions (such as tabs) may include the contact 632.

FIG. 6B shows a schematic 600b having a cross sectional top view of the stator 604 shown in FIG. 6A according to various embodiments. The stator 604 may include a winding portion 634. The winding portion 634 may include an armature winding 618. The stator 604 may further include a non-winding portion 636. The non-winding portion 636 may be substantially free of the armature winding 618. In various embodiments, the non-winding portion 636 may include the contact 632. The contact 632 may be for operable coupling with an adaptor. The stator 604 may be the stator 204 shown in FIGS. 2A-B according to various embodiments and the adaptor may be the adaptor 214 shown in FIG. 2B according to various embodiments. The stator 604 may be the stator 404 shown in FIGS. 4A-C according to various embodiments and the adaptor may be the adaptor 414 shown in FIG. 4C according to various embodiments.

In various embodiments, the non-winding portion 636 may include the radial extension e.g. a tab. The radial extension (e.g. tab) may include the contact. In various embodiments, the non-winding portion 636 may include the plurality of radial extensions e.g. tabs. In various embodiments, one or more of the plurality of radial extensions (e.g. tabs) may include the contact 632.

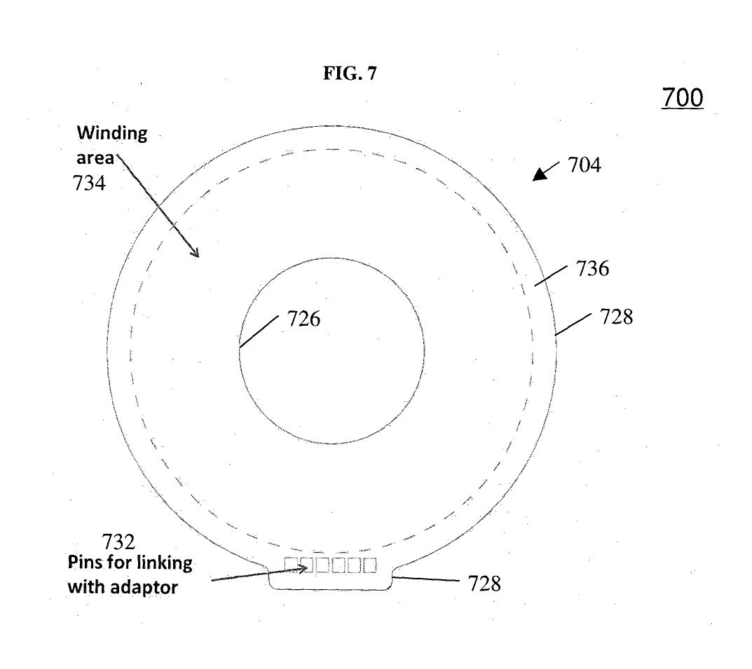

FIG. 7 shows a schematic 700 having a top view of a stator 704 according to various embodiments. In various embodiments, the stator 704 may include an alignment member 730 for aligning the stator 704 to the base. In various embodiments, the alignment member 730 may include only one radial extension of the stator 704. The radial extension may be a tab. The base may include a receiving member (e.g. a complementary recess) for receiving the only one alignment member (e.g. a radial extension such as a tab). In various embodiments, the stator 704 may include a contact 732. The contact 732 may be an electrical pad. The contact 732 may be for operable coupling with a connector so as to establish operable electrical connection with circuitry for operating the motor. In various embodiments, the only one radial extension (or tab) may include the contact 732.

The stator 704 may include a winding portion 734. The winding portion 734 may include an armature winding. The stator 704 may further include a non-winding portion 736. In various embodiments, the non-winding portion 736 may include the contact 732. The contact 732 may be for operable coupling with an adaptor. The stator 704 may be the stator 204 shown in FIGS. 2A-B according to various embodiments and the adaptor may be the adaptor 214 shown in FIG. 2B according to various embodiments. The stator 704 may be the stator 404 shown in FIGS. 4A-C according to various embodiments and the adaptor may be the adaptor 414 shown in FIG. 4C according to various embodiments.

In various embodiments, the non-winding portion 736 may include the only one radial extension or tab. The only one radial extension (e.g. tab) may include the contact.

In various embodiments, a motor may be provided. The motor may include a base, a first rotor, a second rotor and a stator arranged between the first rotor and the second rotor, the stator including an alignment member for aligning the stator to the base.

Various embodiments may provide a motor with a low profile and at the same time is easy to assemble due to the alignment member.

In various embodiments, the stator may include a plurality of alignment member for aligning the stator to the base.

In various embodiments, the base may include a receiving member configured to receive the alignment member. The base may include a plurality of receiving members configured to receive a plurality of alignment members. Each receiving member may be configured to receive one of the plurality of alignment members.

The stator may include an armature winding.

The stator may include a plurality of openings.

The armature winding may include a plurality of coils. Each coil of the plurality of coils may be arranged in a spiral manner around each opening of the plurality of openings.

In various embodiments, the alignment member may include a radial extension of the stator. The radial extension may be or may include a tab. In various embodiments, the alignment member may include a protrusion.

In various embodiments, the base may include a recess configured to receive the radial extension.

In various embodiments, the receiving member may include a recess.

The base may include a plurality of recesses configured to receive the plurality of radial extensions (e.g. tabs) Each recess may be configured to receive one of the plurality of radial extensions (e.g. tabs).

In various embodiments, the stator may include a contact. The contact may be an electrical contact. The contact may be an electrical pin or an electrical pad.

In various embodiments, the radial extension may include the contact. The tab may include the contact.

One or, more of the plurality of radial extensions (e.g. tabs) may include the contact. The contact may be an electrical pin or an electrical pad.

In various embodiments, the stator may include only one aligning member for aligning the stator to the base. The only one aligning member may include the contact.

In various embodiments, the stator includes a winding portion including the armature winding. The stator may further include a non-winding portion including the contact. The contact may be electrically coupled to the armature winding.

The non-winding portion may include the radial extension. The radial extension may be or include the contact.

The winding portion may be substantially annular and adjacent to an inner edge of the stator.

The non winding portion may be substantially annular and adjacent to an outer edge of the stator.

The stator, the first rotor and the second rotor may form a motor sub-assembly.

The motor sub-assembly may be on the base.

A bias ring may be coupled to the stator.

In various embodiments, the base may form at least a portion of a housing. The housing may contain a data storage device in which the motor is a part.

The stator is attached to the base. The stator may be attached to the base using an adhesive. The stator may be attached to the base using fasteners.

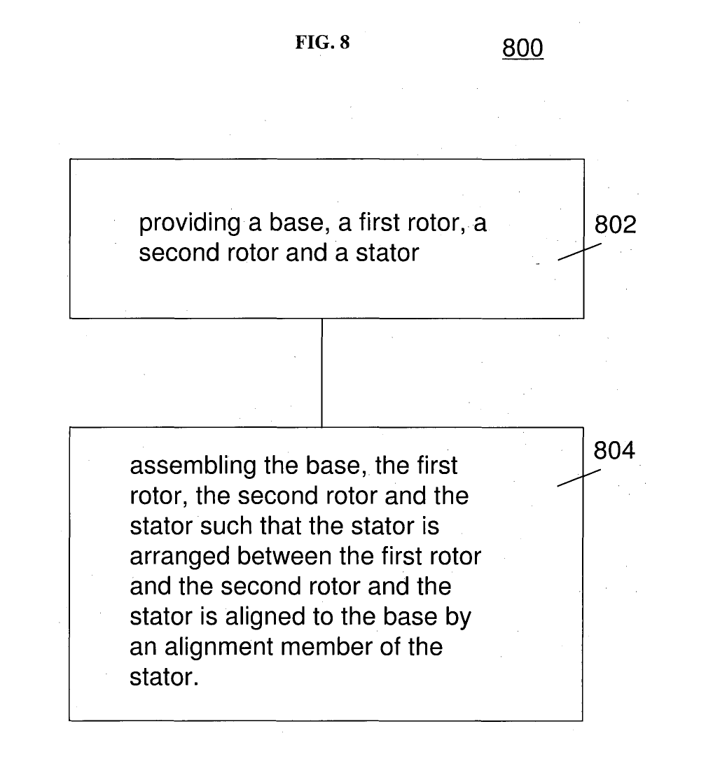

In various embodiments, a method for assembling a motor is provided. FIG. 8 shows a schematic 800 illustrating a method for assembling a motor according to various embodiments. The method may include in 802, providing a base, a first rotor, a second rotor and a stator. The method may further provide in 804, assembling the base, the first rotor, the second rotor and the stator such that the stator is arranged between the first rotor and the second rotor and the stator is aligned to the base by an alignment member of the stator.

The stator may include an armature winding.

The stator may include a plurality of openings.

The armature winding may include a plurality of coils. Each coil of the plurality of coils may be arranged in a spiral manner around each opening of the plurality of openings.

In various embodiments, the alignment member may include a radial extension of the stator. The radial extension may be or may include a tab. The alignment member may include a protrusion.

In various embodiments, the base may include a recess configured to receive the radial extension.

In various embodiments, the receiving member may include a recess.

The base may include a plurality of recesses configured to receive the plurality of radial extensions (e.g. tabs) Each recess may be configured to receive one of the plurality of radial extensions (e.g. tabs).

In various embodiments, the stator may include a contact. The contact may be an electrical contact.

In various embodiments, the radial extension may include the contact. The tab may include the contact.

One or more of the plurality of radial extensions (e.g. tabs) may include the contact. The contact may be an electrical pin or an electrical pad.

In various embodiments, the stator may include only one aligning member for aligning the stator to the base. The only one aligning member may include the contact.

In various embodiments, the stator includes a winding portion including the armature winding. The stator may further include a non-winding portion including the contact. The contact may be electrically coupled to the armature winding.

The non-winding portion may include the radial extension. The radial extension may be or include the contact.

The winding portion may be substantially annular and adjacent to an inner edge of the stator.

The non winding portion may be substantially annular and adjacent to an outer edge of the stator.

The stator, the first rotor and the second rotor may form a motor sub-assembly.

The motor sub-assembly may be on the base.

The method may further include coupling a bias ring to the stator.

In various embodiments, the base may form at least a portion of a housing. The housing may contain a data storage device in which the motor is a part.

The method may include attaching the stator to the base. The stator may be attached to the base using fasteners. Attaching may include attaching using an adhesive such as epoxy. Attaching may also include attaching using fasteners.

While several exemplary embodiments have been presented in the foregoing detailed description of the invention, it should be appreciated that a vast number of variations exist, including variations as to the choice of bearings. It will be understood by one skilled in the art that where fluid dynamic bearings are not used, the bias ring may be an optional feature. Also, the step of pre-assembly should be understood to be optional as the bias ring may be embedded or otherwise provided as an integral part of the stator, etc.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A motor comprising:
a base;
a first rotor;
a second rotor; and
a stator arranged between the first rotor and the second rotor, the stator comprising an alignment member for aligning the stator to the base.

2. The motor according to claim 1,
wherein the stator comprises an armature winding.

3. The motor according to claim 1,
wherein the stator comprises a plurality of openings.

4. The motor according to claim 3,
wherein the stator comprises an armature winding; and
wherein the armature winding comprises a plurality of coils, each coil of the plurality of coils arranged in a spiral manner around each opening of the plurality of openings.

5. The motor according to claim 1,
wherein the alignment member comprises a radial extension of the stator.

6. The motor according to claim 5,
wherein the radial extension is a tab.

7. The motor according to claim 6,
wherein the base comprises
a recess configured to receive the radial extension.

8. The motor according to claim 1,
wherein the stator comprises a contact.

9. The motor according to claim 8,
wherein the alignment member comprises
a radial extension of the stator, the radial extension comprising the contact.

10. The motor according to claim 8,
wherein the stator comprises an armature winding;
wherein the stator comprises
a winding portion comprising the armature winding; and
a non-winding portion comprising the contact; and
wherein the contact is electrically coupled to the armature winding.

11. The motor according to claim 10,
wherein the non-winding portion comprises the radial extension; and
wherein the radial extension comprises the contact.

12. The motor according to claim 10,
wherein the winding portion is substantially annular and adjacent to an inner edge of the stator.

13. The motor according to claim 10,
wherein the non winding portion is substantially annular and adjacent to an outer edge of the stator.

14. The motor according to claim 1,
wherein the stator, the first rotor and the second rotor forms a motor subassembly.

15. The motor according to claim 14,
wherein the motor sub-assembly is on the base.

16. The motor according to claim 1 further comprising:
a bias ring coupled to the stator.

17. The motor according to claim 1,
wherein the base forms at least a portion of a housing.

18. The motor according to claim 17,
wherein the housing contains a data storage device in which the motor is a part.

19. The motor according to claim 1,
wherein the stator is attached to the base.

20. A method of assembling a motor, the method comprising:
providing a base, a first rotor, a second rotor and a stator; and
assembling the base, the first rotor, the second rotor and the stator such that the stator is arranged between the first rotor and the second rotor; and
the stator is aligned to the base by an alignment member of the stator.
